(19) United States
(12) Patent Application Publication
(10) Pub. No.: US 2025/0244009 A1
(43) Pub. Date: Jul. 31, 2025

(54) ILLUMINATED CUSHION

(71) Applicants: Guojun CHEN, Tiantai County (CN); Wei WEI, Hangzhou City (CN)

(72) Inventors: Guojun CHEN, Tiantai County (CN); Wei WEI, Hangzhou City (CN)

(21) Appl. No.: 19/040,437

(22) Filed: Jan. 29, 2025

(30) Foreign Application Priority Data
Jan. 31, 2024 (CN) 2024101317525
Jan. 31, 2024 (CN) 2024202303116

(51) Int. Cl. F21V 33/00; F21V 8/00

(52) U.S. Cl. CPC F21V 33/0028; G02B 6/0006

(57) ABSTRACT

The present disclosure provides an illuminated cushion. The illuminated cushion comprises an outer cover, a soft core, a power supply unit, and a light strip. The outer cover envelops the soft core, the power supply unit supplies power to the light strip, and the light strip is arranged inside piping and/or a decorative trim on lateral edges of the outer cover. By embedding the light strip within the piping and/or decorative trim, the light strip is hidden inside, adding a lighting function to the cushion without altering its external appearance. The light strip can outline the cushion, making it easier to find while also providing lighting and enhancing the ambiance.

### CROSS-REFERENCE TO RELATED APPLICATIONS

This patent application claims the benefit and priority of Chinese Patent Application No. 2024202303116 and Chinese Patent Application No. 2024101317525 both filed with the China National Intellectual Property Administration on Jan. 31, 2024, the disclosures of which are incorporated by reference herein in their entirety as part of the present application.

### Technical Field

The present disclosure belongs to the technical field of home and outdoor patio leisure products, and particularly relates to an illuminated cushion.

### Background

Cushions are frequently used items in households and everyday life, with major categories like pillow cushions and seat cushions. Pillow cushions typically have soft and fluffy fillings, which include standard pillows and throw pillows, while seat cushions are filled more densely. With the improvement of living standards, the usage of cushions has become more varied. Beyond their conventional roles of providing support and seating, they can also serve as decorative items and toys, helping to enhance the ambiance of life.

In the prior art, cushions typically undergo only shape modifications, such as being designed in the form of small animals to evoke a cozy feeling. However, with the expanding range of cushion applications, these modifications no longer satisfy user needs.

### SUMMARY OF THE INVENTION

In view of the shortcomings of the prior art, the present disclosure aims to provide an illuminated cushion to solve the problems related to the limited functionality of cushions in the prior art, specifically their inability to enhance the ambiance during nighttime use and the challenges in locating them.

To achieve the above purpose and other related purposes, the present disclosure provides an illuminated cushion, comprising:
an outer cover, a soft core, a power supply unit, and a light strip,
the outer cover envelops the soft core, and the light strip is arranged inside piping and/or a decorative trim on lateral edges of the outer cover and is powered by the power supply unit.

Optionally, the power supply unit is a power bank or a battery box with a battery.

Optionally, the power supply unit is a power port located on the outer cover, and an external power source supplies power to the light strip through the power port.

Optionally, the soft core is folded and stitched to form an inner pocket, and the power bank is placed in the inner pocket in a removable manner. Optionally, the outer cover is sewn from fabric, the piping on the lateral edges of the outer cover is formed by folding the fabric and leaving a seam allowance area which is then sewn, and the light strip is inserted in the seam allowance area.

Optionally, the decorative trim is fixedly stitched to the lateral edges of the outer cover or detachably arranged on the lateral edges of the outer cover.

Optionally, the decorative trim is a fabric pouch strip, the light strip is threaded through the fabric pouch strip, and the fabric pouch strip is fixedly stitched to the lateral edges of the outer cover or detachably connected to sides of the outer cover.

Optionally, the illuminated cushion further comprises heating pads and/or cooling pads placed between the outer cover and the soft core, and both the upper and lower sides of the cushion are equipped with the cooling pads or the heating pads, or one side is equipped with the heating pads while the other side is equipped with the cooling pads.

Optionally, the light strip is either a self-luminous light strip or optical fiber, and when the light strip is optical fiber, one or both sides of the optical fiber are equipped with a light source.

The light strip may be positioned around the entire perimeter of the seat cushion or pillow; covering all sides (top, bottom, left, and right). Alternatively, it can be placed on only one or more selected sides, such as only the top, bottom, left, or right edges. Additionally, the light strip may be installed exclusively on either the front or back surface, or it may be distributed across multiple sides of both the front and back.

Optionally, the light strip can comprise one or more colors, such as three sub-strips in red, green, and blue colors, with the brightness intensity of each sub-strip being independently controllable.

The illuminated cushion of the present disclosure can have at least the following beneficial effects.

When used at night or in dimly lit settings, the illuminated cushion can enhance the ambiance and is easy to locate. For example, in scenarios such as outdoor parties, garden patios, camping, and open-air cafes, the illuminated cushion can decorate the space and enhance the ambiance, while also marking its own position for easy locating. Additionally, the illuminated cushion provides illumination. Specifically, the illuminated cushion comprises an outer cover, a soft core, a power supply unit, and a light strip. The outer cover envelops the soft core, and the soft core is folded to form an inner pocket where the power supply unit is placed to power the light strip. The light strip is arranged inside piping and/or a decorative trim on lateral edges of the outer cover. By embedding the light strip within the piping/decorative trim, the light strip is concealed inside, adding a luminous function without altering the external appearance. The light strip can outline the cushion, making it easier to find while also providing lighting and enhancing the ambiance.

Inside the piping or decorative trim, the light strip is embedded in a way that allows the piping/trim to serve a dual function-both as a decorative element and as a structural component for housing and diffusing the light emitted by the light strip. Unlike conventional piping, which is solely ornamental, this design transforms the piping/trim into an integral part of the illumination system, enhancing both aesthetics and functionality. The interaction between the piping/trim and the light strip results in a synergistic effect, where the piping not only conceals and protects the light strip but also helps to diffuse and distribute the emitted light in a visually appealing manner. This innovative combination ensures that the light strip is seamlessly integrated into the cushion without compromising the overall design, making the illumination appear as a natural extension of the cushion rather than an add-on component. The focus is on how the piping/trim and the light strip work together to create an enhanced lighting effect that neither component could achieve independently.

### BRIEF DESCRIPTION OF DRAWINGS

FIG. 1 is a schematic diagram of an illuminated cushion of the present disclosure when used as a pillow:

FIG. 2 illustrates schematic diagrams of an illuminated cushion of the present disclosure being used as a pillow and a seat cushion respectively.

FIG. 3 is a schematic diagram of a cross-section and seam allowance area of an illuminated cushion of the present disclosure.

FIG. 4 is a schematic diagram of a cross-section and fabric pouch strip of an illuminated cushion of the present disclosure.

FIG. 5 is a schematic diagram of a soft core inner pocket of an illuminated cushion of the present disclosure.

FIG. 6 shows how a cushion of the present disclosure is used in conjunction with other elements.

Description of reference numerals: outer cover 1, seam allowance area 10, fabric pouch strip 11, soft core 2, inner pocket 20, power port 30, light strip 4, sub-strips 4a, 4b, 4c, light source 7, temperature control pad 15.

### DETAILED DESCRIPTION OF THE INVENTION

The following specific embodiments illustrate the implementation of the present disclosure. Those skilled in the art can easily understand other advantages and effects of the present disclosure based on the content disclosed in this specification.

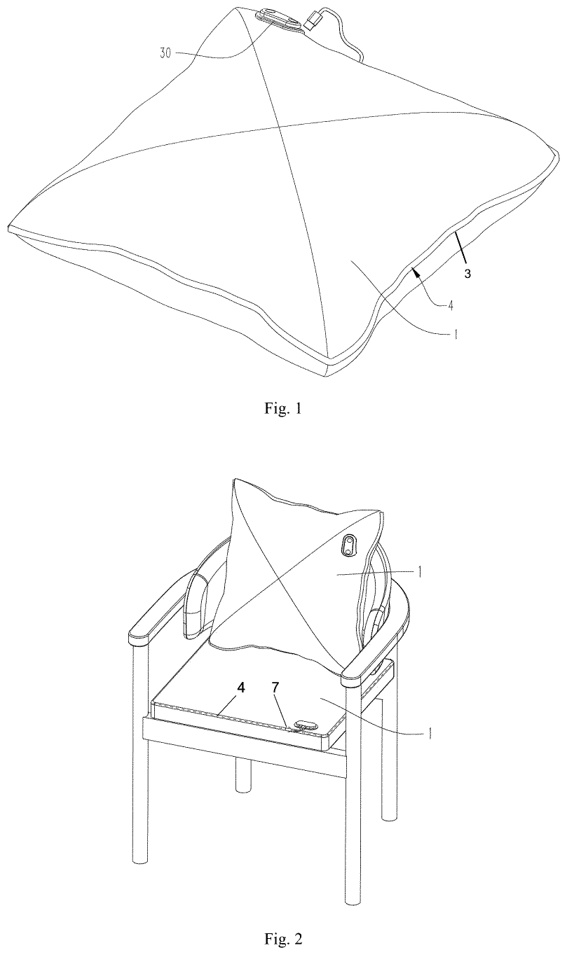

Refer to FIGS. 1-5. It should be noted that the structures, proportions, sizes, etc., depicted in the drawings are only for the purpose of supporting the content disclosed in the specification, to aid those skilled in the art in understanding and reading, and are not intended to limit the conditions under which the present disclosure can be implemented. Any modifications to the structure, changes in proportional relationships, or adjustments in size, as long as they do not affect the effects and objectives that the present disclosure can achieve, should still fall within the scope covered by the technical content disclosed in the present disclosure. Additionally, terms such as “upper,” “lower,” “left,” “right,” “middle,” and “one” cited in this specification are merely for the sake of clarity in description and are not intended to limit the range of implementation of the present disclosure. Any changes or adjustments in their relative relationships, without substantially altering the technical content, shall also be regarded as falling within the scope of implementation of the present disclosure.

The following embodiments are intended only as examples. Each embodiment can be combined with others, and they are not restricted to the content shown in any individual embodiment.

This embodiment, as shown in FIGS. 1 and 2, provides an example of an illuminated cushion, comprising an outer cover 1, a soft core 2, a power supply unit 30, and a light strip 4. The outer cover 1 envelops the soft core 2, and the light strip 4 is arranged inside a decorative trim 3 on lateral edges of the outer cover 1 and is powered by the power supply unit. The light strip is either a self-luminous light strip or optical fiber, and when the light strip is optical fiber, one or both ends of the optical fiber are equipped with a light source 7. In specific implementations, depending on the different uses of the cushion, various types of soft cores 2 can be used, achieved by altering the filling material of the soft core 2. For example, when used as a throw pillow or standard pillow; it is generally filled with fluffy fiber, while when used as a seat cushion, it is typically filled with dense fiber. Additionally, as shown in FIGS. 2 and 6, a pillow and a seat cushion are both provided for combined use. For instance, in FIG. 2, the pillow and seat cushion are used together with a chair, while in FIG. 6, the pillow and seat cushion are connected by flexible fabric for easy storage and portability, enhancing usability. In specific implementations, common filling materials include PP fiber, non-glue fiber, spray-bonded fiber, sponge, foam particles, down, herbal plants, microbeads, beans, rice husks and pure cotton, which can be selected based on different fluffiness requirements. The light strip 4 arranged around the lateral edges of the cushion can enhance the ambiance. For example, the light strip can increase the festive, birthday, or party ambiance and aesthetic appeal, while also soothing crying children and serving as emergency lighting. The luminous function boosts the ambiance and decorative appeal in scenarios such as outdoor parties, garden patios, camping, and open-air cafes. The light strip may also serve as emergency outdoor lighting and facilitates the location of the cushion, making it easy to find. Additionally, in this embodiment, the light strip 4 is arranged inside the decorative trim 3 on the lateral edges of the outer cover 1, which has almost no impact on the design of the outer cover and soft core of the cushion, nor does it affect the external shape and aesthetics of the cushion. However, when used at night, the light strip significantly enhances the usability and visual appeal of the cushion.

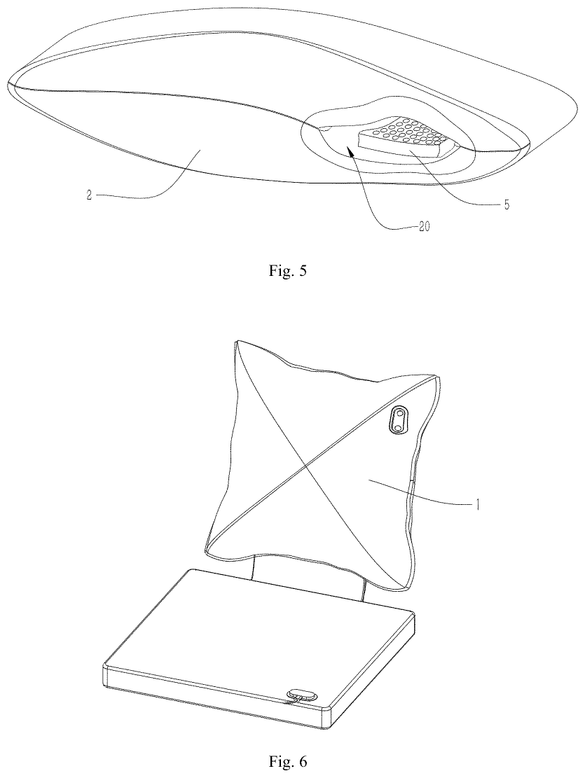

In some embodiments, the power supply unit is a power bank 5 or a battery box with a battery (FIG. 5). A power bank is a commonly used tool in daily life and is convenient for outdoor use as a power source. When a power bank is not available, external power may also be supplied through a power port 30 on the outer cover 1. The two methods can be used in conjunction: for example, the power bank mode is more convenient when camping outdoors, while at home, it can be directly connected to an external power source via a power adapter. In the external power supply mode, the power supply unit is the power port 30 located on the outer cover 1, and the external power source supplies power to the light strip 4 through the power port 30.

In this embodiment, as illustrated in FIGS. 3-5, the soft core 2 is folded and stitched to form an inner pocket 20, and the power bank 5 is placed in the inner pocket 20 in a removable manner. The material on the surface of the inner pocket 20 may be flame-retardant. The production method for the inner pocket 20 is simple and convenient, ensuring that the power bank remains separate from the filling material in the soft core 2, with the power bank always positioned in the center of the soft core 2. This prevents the power bank from shifting in the soft core 2 during use, avoiding scenarios where the power bank may lead to one side, causing discomfort to the user or potentially being crushed. As a separate component, the power bank can be easily removed from and reinserted into the inner pocket 20. Once removed, the power bank can also supply power to a mobile phone or other devices.

In this embodiment, as illustrated in FIG. 3, the outer cover 1 is sewn from fabric, the decorative trim 3 on the lateral edges of the outer cover 1 is piping formed by folding the fabric and leaving a seam allowance area 10 which is then sewn, and the light strip 4 is inserted in the seam allowance area 10. This method is relatively simple to implement. The fabric to be used for the outer cover is folded, leaving an appropriate allowance at the folded section, and then sewn together to form the seam allowance area 10. The light strip is then threaded through the seam allowance area 10, allowing the light strip 4 to be hidden inside the piping 3 formed by the seam allowance area 10. From the outside, the light strip is not visible: however, when the light strip is powered on, the light can pass through the fabric, creating a glowing ring around the cushion that outlines its shape, resulting in a strong visual effect.

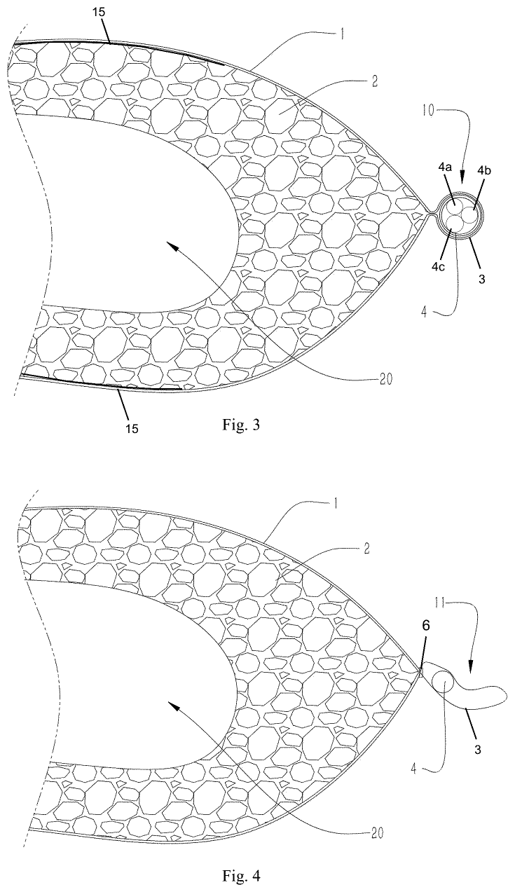

In this embodiment, as illustrated in FIG. 4, the decorative trim 3 is fixedly stitched to the lateral edges of the outer cover 1 or detachably arranged on the lateral edges of the outer cover 1. In practical implementation, the decorative trim is a fabric pouch strip 11, the light strip 4 is threaded through the fabric pouch strip 11, and the fabric pouch strip 11 is detachably connected to sides of the outer cover 1 using Velcro fasteners or buckles. In terms of specific operations, long edges of a strip fabric are folded and sewn together to form a tubular shape, and then the light strip 4 is threaded through the tube. Finally, both ends are sealed to create the fabric pouch strip 11. Multiple Velcro fasteners may be spaced along the fabric pouch strip 11, with additional Velcro fasteners spaced around the perimeter of the cushion. This allows the fabric pouch strip 11 to be detachably secured to the cushion, enhancing the aesthetic appeal of the cushion and enabling the replacement of different colors and designs of the fabric pouch strip 11 according to different scenarios, thus improving the usability of the cushion.

In FIG. 3, the illuminated cushion further comprises temperature control pads 15, which can be heating pads and/or cooling pads placed between the outer cover 1 and the soft core 2, and both the upper and lower sides of the cushion are equipped with the cooling pads or the heating pads, or one side is equipped with the heating pads while the other side is equipped with the cooling pads. The cooling pads or heating pads may be attached to the inner side of the outer cover or the outer side of the soft core 2, configured in a detachable manner. This design facilitates easy removal for cleaning the cushion, as well as the replacement of the cooling pads or heating pads in different seasons.

In this embodiment, the light strip 4 may comprise at least two independently controlled sub-strips, each with a different luminous color. Such as, the light strip 4 comprises three sub-strips (4a, 4b, 4c) in red, green, and blue colors, with the brightness intensity of each sub-strip being independently controllable. Red, green, and blue are three primary colors of light, and by controlling the brightness intensity of the three colored sub-strips (4a, 4b, 4c), a wider variety of colors can be created, enhancing the lighting effects without the need for additional colored sub-strips.

In summary, the present disclosure effectively overcomes various shortcomings of the prior art, achieving beneficial technical effects and demonstrating significant advancements.

The above embodiments are merely illustrative of the principles and effects of the present disclosure and are not intended to limit it. Any person skilled in the art may modify or change the above embodiments without departing from the spirit and scope of the present disclosure. Therefore, any equivalent modifications or changes made by those with ordinary knowledge in the relevant technical field, without deviating from the spirit and technical concepts disclosed in the present disclosure, should still be covered by the claims of the present disclosure.

1. A cover for an illuminated cushion, comprising a fabric outer cover and a light strip, wherein the light strip is arranged inside decorative trim on lateral edges of the outer cover; and
a power supply unit powering the light strip,
wherein the decorative trim is a fabric piping or a fabric pouch strip,
wherein the light strip is hidden from view by fabric of the decorative trim when the light strip is powered off, and
wherein light from the light strip passes through the fabric of the decorative trim when the light strip is powered on.

2. An illuminated cushion, comprising the cover according to claim 1, and a soft core enclosed by the outer cover.

3. The illuminated cushion according to claim 2, wherein the power supply unit is a power bank or a battery box with a battery.

4. The illuminated cushion according to claim 2, wherein the power supply unit is a power port located on the outer cover, allowing the light strip to be powered by an external power source through the power port.

5. The illuminated cushion according to claim 3, wherein the soft core is folded and stitched to form an inner pocket, and the power bank is hidden in the inner pocket in a removable manner.

6. The cover according to claim 1, wherein the outer cover is made of fabric, with the decorative trim on the lateral edges of the outer cover formed by folding the fabric to create a seam allowance area, which is subsequently sewn, and the light strip is inserted in the seam allowance area.

7. The cover according to claim 1, wherein the decorative trim is piping having the same cross-sectional shape as the light strip.

8. The cover according to claim 1, wherein the decorative trim is fixedly stitched to the lateral edges of the outer cover.

9. The cover according to claim 1, wherein the decorative trim is detachably arranged on the lateral edges of the outer cover.

10. The cover according to claim 1, wherein the decorative trim is a fabric pouch strip, and the light strip is threaded through the fabric pouch strip.

11. The illuminated cushion according to claim 2, further comprising at least one temperature control pad positioned between the outer cover and the soft core.

12. The illuminated cushion according to claim 11, wherein the at least one temperature control pad includes a heating pad and/or cooling pad.

13. The illuminated cushion according to claim 11, wherein the at least one temperature control pad includes a first temperature control pad on an upper side of the cushion and a second temperature control pad on a lower side of the cushion.

14. The cover according to claim 1, wherein the light strip is a self-luminous light strip.

15. The cover according to claim 1, wherein the light strip is an optical fiber and one or both ends of the optical fiber are equipped with a light source.

16. The cover according to claim 1, wherein the light strip comprises multiple sub-strips each in a different color, with the brightness intensity of each sub-strip being independently controllable.

17. The cover according to claim 1, wherein the light strip is not directly visible from outside the cover due to the fabric of the decorative trim.

18-19. (canceled)

20. The cover according to claim 1, wherein light from the light strip creates a glowing ring around the cover from inside the trim.
